(19) United States
(12) Patent Application Publication
(10) Pub. No.: US 2008/0314096 A1
(43) Pub. Date: Dec. 25, 2008

(54) Door Lock

(76) Inventor: Jong Il Kim, Seoul (KR)

Correspondence Address: LADAS & PARRY LLP, 224 SOUTH MICHIGAN AVENUE, SUITE 1600, CHICAGO, IL, 60604, US

(21) Appl. No.: 11/573,798

(22) PCT Filed: Aug. 17, 2005
(86) PCT No.: PCT/KR2005/002681

§ 371 Date: Feb. 16, 2007

(30) Foreign Application Priority Data
Aug. 17, 2004 (KR) 10-2004-0064911

(51) Int. Cl. E05B 65/00

(52) U.S. Cl. 70/91

(57) ABSTRACT

A door lock is provided, which can open and close the door by pushing or pulling a handle of the door lock as well as by rotating the handle, to thereby make users use the door lock conveniently. The door lock includes: inner and outer flanges; a sleeve; inner and outer handles; an operating cam; a spring; and a holder, wherein the operating cam includes an operating groove formed in any one side of the operating cam and predetermined slanted planes formed at both sides thereof, wherein the rotating unit operates by the slanted planes during manipulation of the rotation, and wherein the rotating unit operates by the end of the operating groove during manipulation of the linear movement.

### TECHNICAL FIELD

The present invention relates to a door lock, and more particularly to, a door lock which can open and close a door by pushing or pulling a handle of the door lock as well as by rotating the handle, to thereby make users use the door lock conveniently.

### BACKGROUND ART

In general, door locks are used for opening and closing doors in homes or offices. It is well known that the door lock is used for opening and closing a door by rotating one of handles installed in the inner and outer sides of the door. The handles which are used for the door lock are chiefly formed of spherical members or L-shaped members which are attached to both ends of a sleeve penetrating the door, respectively.

In the case of a conventional door lock, a tubular sleeve penetrates a door at a proper height of the door. A main body including various door locking and releasing components is installed at the edge of the sleeve. Also, inner and outer flanges are fixed between both ends of the sleeve and the door. A handle which is an opening and closing unit is installed in the end of the sleeve protruding between the inner and outer flanges. A locking device including a slider is installed in the handle.

Also, an operating arm which operates by the inner and outer handles and the locking device is installed in the door. and a locker connected with the operating arm is installed in a door frame. Accordingly, the door is opened and closed when the locker connected with the operating arm is inserted into and released from the holder fixed to the door frame by the manipulation of rotating one of the handles.

However, the conventional door lock opens and closes a door by only rotational manipulation of the handles. Here, in the case that hands are smeared with slippery materials such as water or soap or oil, it is difficult to rotate the handles to open and close the door, to thereby cause users to be inconvenienced at the time of opening and closing the door. In particular, in the case of children who are not accustomed to manipulate one of the handles rotationally, they suffer from considerable difficulties in opening and closing the door.

Also, since the conventional door lock has a structure of opening and closing a door only by rotation of the handle, the lifetime of the door lock is reduced due to continuous friction and wear between components during opening and closing a door. Also, the number of components is large, to cause a production cost to increase and a frequent malfunction to occur. Although a door is closed, the door may be opened by using a blade, a knife, a pick, or a steel wire, to thereby make users feel uneasy and decline a locking effect.

### DISCLOSURE OF THE INVENTION

To solve the above problems, it is an object of the present invention to provide a door lock which has improved a door lock proposed by the same applicant as this invention, which is disclosed in Korea Utility Model Registration No. 20-0275073, and which can open and close a door by pushing or pulling a handle of the door lock as well as by rotating the handle, to thereby make users use the door lock conveniently.

To accomplish the above object of the present invention, according to an aspect of the present invention, there is provided a door lock comprising: inner and outer flanges attached in the inner and outer sides of the door; a sleeve penetrating the inner and outer flanges and buried in the door so as to be rotated axially and moved in the front and rear direction; inner and outer handles axially installed in both ends of the sleeve; an operating cam installed in the sleeve so as to be rotated and moved linearly by manipulation of the inner and outer handles and making a rotating unit in a holder operate; a spring installed in the operating cam and restoring the operating cam into an original position if the operating cam has operated; and the holder in which the rotating unit, the operating unit and the locker have tension by springs and are internally installed so as to rotate in one direction by rotation and linear movement of the operating cam and allowing a locker to be inserted into or released from a locker plate, wherein the operating cam includes an operating groove formed in any one side of the operating cam and predetermined slanted planes formed at both sides thereof, wherein the rotating unit operated by the slanted planes during manipulation of the rotation, and wherein the rotating unit operates by the end of the operating groove during manipulation of the linear movement.

Preferably, a stop ring is further comprised in the end of the operating cam.

Preferably, the outer diameter of the holder is formed as a taper whose leading end diameter narrows.

Preferably, a rubber packing is further installed in the holder.

### BRIEF DESCRIPTION OF THE DRAWINGS

The above and other objects and advantages of the present invention will become more apparent by describing the preferred embodiment thereof in detail with reference to the accompanying drawings in which:

FIG. 1 is a cross-sectional view showing an assembly state where a door lock according to the present invention is applied to a push-to-open door;

FIG. 2 is a cross-sectional view of an operating cam viewed along a line I-I of FIG. 1;

FIG. 3 is a left-hand side view of FIG. 2;

FIG. 4 is a rear view of FIG. 2 for explaining an installation state of a spring;

FIG. 5 is a cross-sectional view showing an assembly state where a door lock according to the present invention is applied to a pull-to-open door;

FIG. 6 is a cross-sectional view of an operating cam viewed along a line II-II of FIG. 5;

FIG. 7 is a left-hand side view of FIG. 6;

FIG. 8 is a front view of a stop ring which is combined with the operating cam of FIG. 6;

FIG. 9 is a cross-sectional view viewed along a line A-A of FIG. 8;

FIG. 10 is a cross-sectional view viewed along a line B-B of FIG. 8;

FIG. 11 is a cross-sectional view showing the state where the stop ring of FIG. 9 is combined with the operating cam of FIG. 6;

FIG. 12 is a view showing the state where a rubber packing is installed in a holder body which is applied to a door lock according to the present invention; and

FIG. 13 is a cross-sectional view viewed along a line C-C of FIG. 11.

### BEST MODE FOR CARRYING OUT THE INVENTION

Hereinbelow, a door lock according to the present invention will be described with reference to the accompanying drawings.

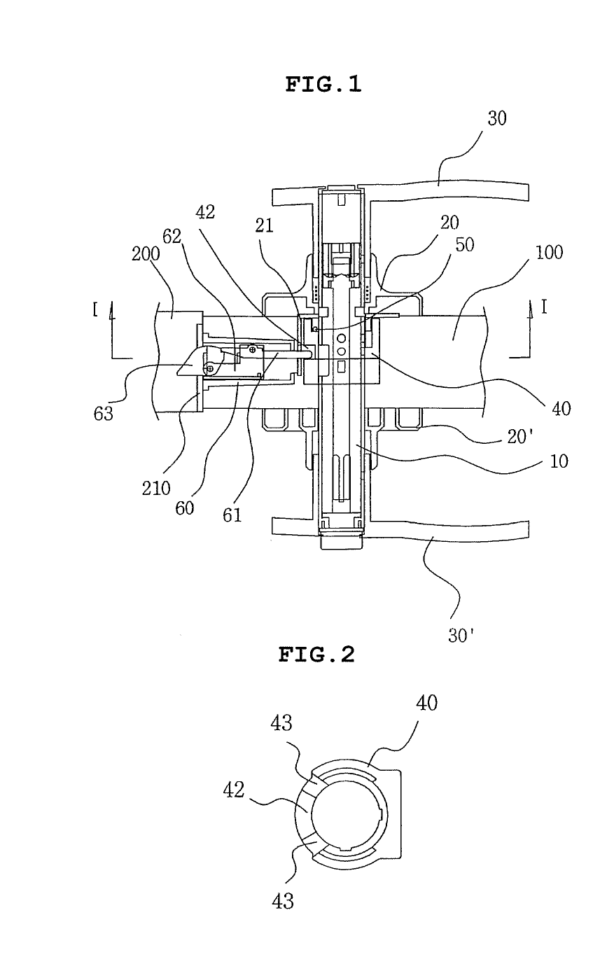

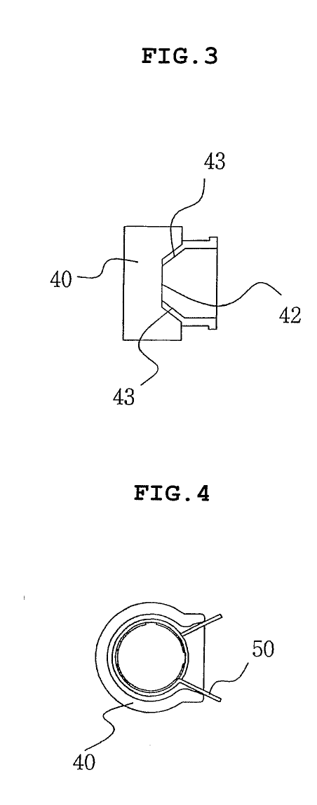

FIG. 1 is a cross-sectional view showing an assembly state where a door lock according to the present invention is applied to a push-to-open door. FIG. 2 is a cross-sectional view of an operating cam viewed along a line I-I of FIG. 1. FIG. 3 is a left-hand side view of FIG. 2. FIG. 4 is a rear view of FIG. 2 for explaining an installation state of a spring.

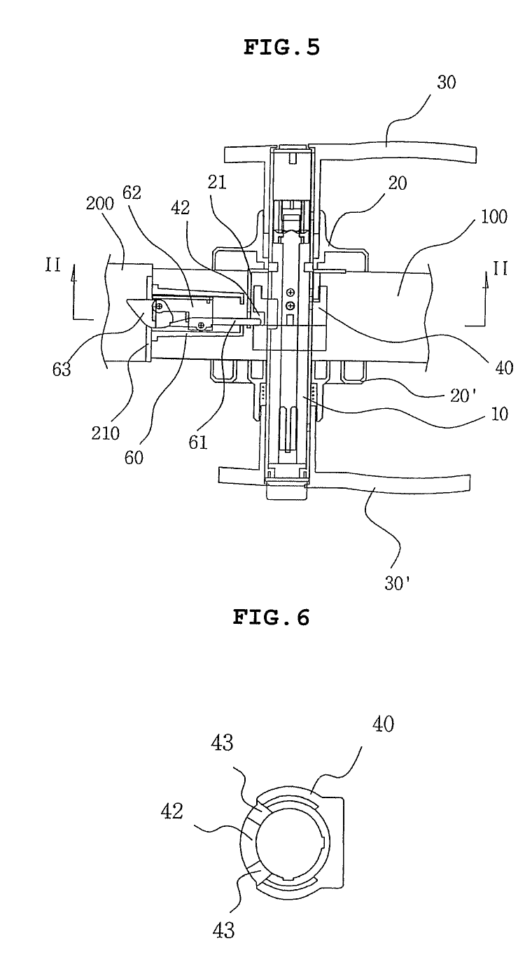

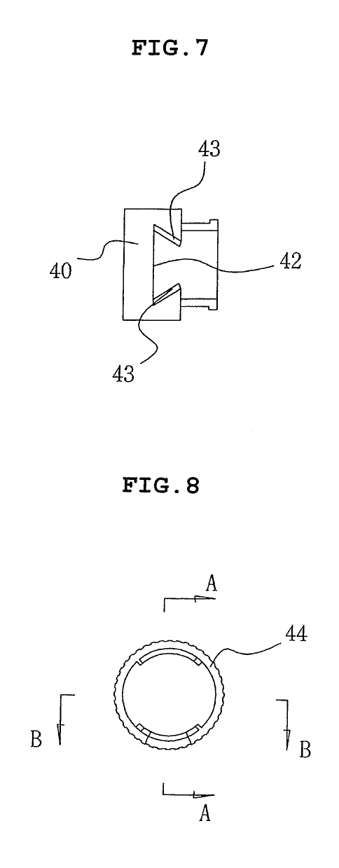

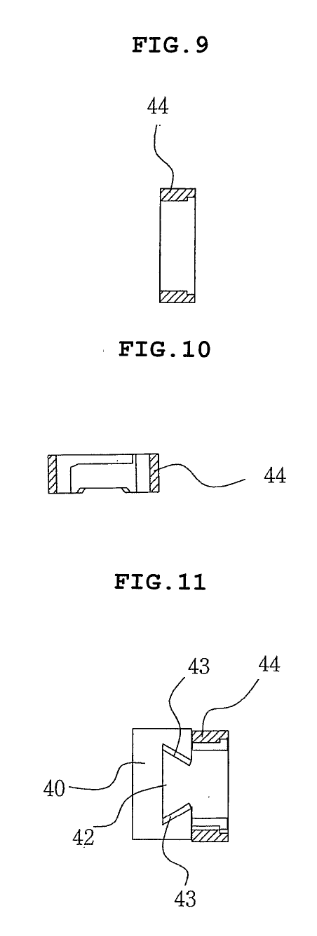

FIG. 5 is a cross-sectional view showing an assembly state where a door lock according to the present invention is applied to a pull-to-open door. FIG. 6 is a cross-sectional view of an operating cam viewed along a line II-II of FIG. 5. FIG. 7 is a left-hand side view of FIG. 6. FIG. 8 is a front view of a stop ring which is combined with the operating cam of FIG. 6. FIG. 9 is a cross-sectional view viewed along a line A-A of FIG. 8. FIG. 10 is a cross-sectional view viewed along a line B-B of FIG. 8. FIG. 11 is a cross-sectional view showing the state where the stop ring of FIG. 9 is combined with the operating cam of FIG. 6.

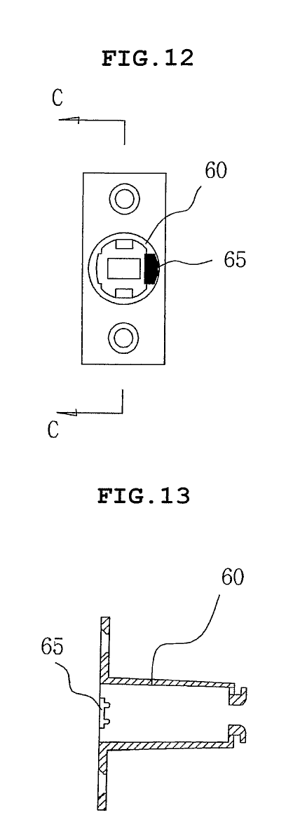

FIG. 12 is a view showing the state where a rubber packing is installed in a holder body which is applied to a door lock according to the present invention. FIG. 13 is a cross-sectional view viewed along a line C-C of FIG. 11.

Referring to FIG. 1 or 5, a door lock according to the present invention includes a cylindrical sleeve 10. The sleeve penetrates a door 100 and inner and outer flanges 20 and 20′ attached to the inner and outer sides of the door 100, and buried in the door so as to be rotated axially and moved in the front and rear direction. The sleeve 10 is a cylindrical tube and is penetratively installed at a proper position on the door 100 so as to be freely rotated axially and moved in the front and rear direction.

The door lock according to the present invention includes inner and outer handles 30 and 30′. The inner and outer handles 30 and 30′ are axially installed in both ends of the sleeve 10 protruding outwards from the inner and outer flanges 20 and 20′, to thereby open and close the door substantially. The inner and outer flanges 20 and 20′ are attached to both sides of the door 100 to thereby support the sleeve 10 penetrating the door 100 and to thus prevent the sleeve 10 from moving at the time when the sleeve 10 rotates and moves in the front and rear direction.

Also, the inner and outer handles 30 and 30′ are fitted into and fixed to the ends of sleeve 10 protruding outwards from the inner and outer flanges 20 and 20′. The inner and outer handles 30 and 30′ are manipulated to make the sleeve 10 rotate axially and move in the front and rear direction, to thus open and close the door 100.

The door lock according to the present invention includes an operating cam 40. The operating cam 40 is fixedly installed in the sleeve 10 between the inner and outer flanges 20 and 20′. The operating cam 40 is an essential element which is a characterized portion of the present invention. The operating cam 40 is fitted into and fixed the sleeve 10 between the inner and outer flanges 20 and 20′, and operates movably together with the sleeve 10.

As shown in FIG. 2, an operating groove 42 is provided in any one side of the operating cam 40. Predetermined slanted planes 43 are provided at both sides of the operating groove 42. A rotating unit operates by the slanted planes 43 during manipulation of the rotation, and the rotating unit operates by the end of the operating groove 42 during manipulation of the linear movement.

In the case that the operating groove 42 and the slanted planes 43 included in the operating cam 40 are applied to a push-to-open door as shown in FIGS. 1 through 4, the slanted planes 43 formed in both sides of the operating groove 42 are formed in an opened state, while in the case that the operating groove 42 and the slanted planes 43 included in the operating cam 40 are applied to a pull-to-open door as shown in FIGS. 5 through 10, the slanted planes 43 formed in both sides of the operating groove 42 are formed in a reverse direction to those of the slanted planes 43 included in the operating cam 40 applied in the push-to-open door.

A stop ring 44 is combined with the end of the operating cam 40 which is shown in FIG. 11.

The door lock according to the present invention includes a spring 50. The spring 50 restores the operating cam 40 which is rotationally moved by the sleeve 10 into an original position, and is installed in the operating cam 40 as shown in FIG. 4 and both ends of the spring 50 is installed in an auxiliary flange 21 fixed to the inner flange 20. That is, the spring 50 is positioned in the inner circumferential surface opposing the surface in the operating cam 40 where the operating groove 42 and the slanted planes 43 are formed, and is installed so as to interact with the auxiliary flange 21 fixed to the inner flange 20. Accordingly, the spring 50 restores the operating cam 40 into an original position when the operating cam 40 is rotationally moved.

The door lock according to the present invention includes a holder 60. A rotating unit 61 contacting the operating cam 40, an operating unit 62 which rotationally moves in any one direction by the rotating unit 61, and a locker 63 are internally installed in the holder 60. The rotating unit 61, the operating unit 62 and the locker 63 possess tension by springs, and thus the locker 63 is inserted into and released from a locker plate 210 in a door frame 200.

Also, a spring is mounted at the upper-central end of the inner flange 20, to always push the lower end of the body of the operating unit 62. Accordingly, a clearance is formed in the body of the operating unit 60, and thus the operating unit 62 can smoothly operate irrespective of thickness of the door.

The holder 60 is buried in the end of the door 100 in a direction perpendicular with the sleeve 10. The operating unit 62 is elastically installed in the holder 60 together with a compression spring. The locker 63 is rotatably installed in the leading end of the operating unit 62 together with a tension spring. The rotating unit 61 is rotatably installed in the rear end of the operating unit 62 together with a tension spring, and the leading end of the rotating unit 61 elastically contacts the protrusion and the rear end thereof penetrates the holder 60 and is positioned in the operating groove 42 in the operating cam 40.

The operating unit 62 has a bracket shape and is internally installed in the holder 60 elastically together with two compression springs from the leading end of the holder 60, so that the operating unit 62 can be freely moved in the lengthy direction. Also, the locker 63 is rotatably hinged with the leading end of the operating unit 62 together with a tension spring, and a protrusion is formed in opposition to the hinge. Also, the rotating unit 61 is rotatably connected with the rear end of the operating unit 62 together with a tension spring, in which the leading end of the rotating unit 61 elastically contacts the protrusion of the locker 63 and the rear end thereof penetrates the holder 60 and is installed and positioned in the operating groove 42 in the operating cam 40.

The holder 60 is buried in the end of the door 100 in a direction perpendicular with the sleeve 10. The leading end of the holder 60 is installed toward the locker plate 210 in the door frame 200. The holder 60 is cylindrically formed and the outer diameter of the holder 60 is formed as a taper that the diameter of the leading end narrows in order to be accurately installed in the door 100 (refer to FIG. 12). That is, the outer diameter of the leading end of the holder 60 narrows and that of the rear end thereof widens. In other words, the holder 60 is tapered, so as to be accurately installed in the door 100.

Also, as shown in FIG. 12, a rubber packing 65 is further installed in the holder 60, in order to protect components internally installed in the holder 60. That is, wear due to operation of the operating components such as the operating unit and locker is minimized by the rubber packing 65, to thereby prolong the lifetimes of the operating components. Graphite rubber is preferably used as the rubber packing 65.

The door lock according to the present invention having the above-described structure is at the following states when a door is at a non-operation state. The operating unit 62 in the holder 60 is positioned toward the door frame 200. The rotating unit 61 is installed in parallel with the holder 60 by an elastic force of a tension spring. Here, the leading end of the rotating unit 61 supports the protrusion of the locker 63, and the rear end thereof is positioned at the center of the operating groove 42 in the operating cam 40. In this case, the door 100 is at a state where it is completely closed or opened.

In this state, if a user rotates any one of inner and outer handles 30 and 30′, the sleeve 10 rotates together with the rotating handles and the operating cam 40 rotates at the same time when the sleeve 10 rotates.

If the operating cam 40 rotates, the slanted planes 43 formed at both sides of the operating groove 42 contact the rotating unit 61, and simultaneously the rear end of the rotating unit 61 moves in a lateral direction by the slanted planes 43. Here, the leading end of the rotating unit 61 rotates around the hinge to then secede from the protrusion of the locker 63. As soon as the rotating unit 61 secedes from the protrusion of the locker 63, the locker 63 rotates around the hinge and is inserted into the holder 60. Thus, since the locker 63 secedes from the locker plate 210 in the door frame 200, the door 100 can be opened.

Meanwhile, if any one of the inner and outer handles 30 and 30′ are pushed or pulled at the state where the door 100 has been locked, that is, if a push-to-open door shown in FIG. 1 is pushed, and if a pull-to-open door shown in FIG. 5 is pulled, the sleeve 10 also moves in the same direction as that of the pushed or pulled handle. Simultaneously, the operating cam 40 fixed to the sleeve 10 also moves.

Thus, as the operating cam 40 moves, the rear end of the rotating unit 61 positioned in the operating groove 42 is engaged with the operating groove 42. Thus, the rear end of the rotating unit 61 moves in a lateral direction, and the rotating unit rotates around the hinge. In this case, since the leading end of the rotating unit 61 secedes from the protrusion of the locker 63, the locker 63 secedes from the locker plate 210 in the same operation as the previously described operation. As a result, the door 100 can be easily opened.

In operation, if the hand holding the handle is released at the state where the handle is rotated or pushed, the handle is restored by the spring 50 installed between the auxiliary flange 21 and the operating cam 40, to thus restore the locker 63 into an original state.

As described above, as a user rotates one of the inner and outer handles, the sleeve is rotated. If the sleeve rotates, one end of the rotating unit rotates in which the rotating unit is positioned in the operating groove of the operating cam which is axially installed in the sleeve. Here, the one end of the rotating unit contacts the rear end of the locker. Accordingly, the locker rotates and secedes from or inserted into the holder fixed to the door frame. Thus, the door can be opened and closed.

Also, if a user pushes or pulls one of the inner and outer handles, the operating cam moves in an axial direction together with the sleeve. Accordingly, one end of the rotating unit positioned in the operating groove of the operating cam rotates and supports the rear end of the locker or secedes from the rear end of the locker. Thus, the locker rotates and secedes from and inserted into the holder, so that the door can be opened and closed.

### INDUSTRIAL APPLICABILITY

As described above, the present invention provides a door lock which can open and close a door by pushing or pulling a handle of the door lock as well as by rotating the handle, to thereby make users use the door lock conveniently. The door lock according to the present invention has merits of having a smooth operation and noiselessness due to small wear and friction between components. Also, the total lifetime of the door lock can be extended together with prevention of damage because of small wear between components.

As described above, the present invention has been described with respect to a particularly preferred embodiment. However, the present invention is not limited to the above embodiment, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A door lock comprising:
inner and outer flanges attached in the inner and outer sides of the door;
a sleeve penetrating the inner and outer flanges and buried in the door so as to be rotated axially and moved in the front and rear direction;
inner and outer handles axially installed in both ends of the sleeve;
an operating cam installed in the sleeve so as to be rotated and moved linearly by manipulation of the inner and outer handles and making a rotating unit in a holder operate;
a spring installed in the operating cam and restoring the operating cam into an original position if the operating cam has operated; and
the holder in which the rotating unit, the operating unit and the locker have tension by springs and are internally installed so as to rotate in one direction by rotation and linear movement of the operating cam and allowing a locker to be inserted into or released from a locker plate,
wherein the operating cam includes an operating groove formed in any one side of the operating cam and predetermined slanted planes formed at both sides thereof,
wherein the rotating unit operated by the slanted planes during manipulation of the rotation, and
wherein the rotating unit operates by the end of the operating groove during manipulation of the linear movement.

2. The door lock according to claim 1, wherein a stop ring is further comprised in the end of the operating cam.

3. The door lock according to claim 1, wherein the outer diameter of the holder is formed as a taper whose leading end diameter narrows.

4. The door lock according to claim 1, wherein a rubber packing is further installed in the holder.
